(19) United States
(12) Patent Application Publication
(10) Pub. No.: US 2004/0177517 A1
(43) Pub. Date: Sep. 16, 2004

(54) Microedged shaving surface and a method for making the same

(75) Inventors: Brian G. Balistee, Milford, CT (US); Randy Nicolosi, Shelton, CT (US)

Correspondence Address: Richard R. Michaud, McCormick, Paulding & Huber LLP, CityPlace II, 185 Asylum Street, Hartford, CT, 06103, US

(73) Assignee: Eveready Battery Company, Inc., Westlake, OH

(21) Appl. No.: 10/775,698

(22) Filed: Feb. 10, 2004

Related U.S. Application Data
(60) Provisional application No. 60/446,292, filed on Feb. 10, 2003.

(51) Int. Cl. B21K 11/00; B26B 21/54

(52) U.S. Cl. 30/346.57; 76/104.1

(57) ABSTRACT

In a method for making a microedged shaving surface a substrate is provided having a polymer layer applied on at least one surface thereof. An edge layer of material is applied over the polymer layer and has a hardness sufficient to support a cutting edge. At least one surface of the substrate is coated with a photoresist material that is positioned over the edge layer. The photoresist material is cured to render areal portions thereof substantially impervious to removal by etching. The photoresist material is then etched so that the areas adjacent to the substantially impervious areas create a plurality of re-entrant profiles. Any remaining photoresist material is stripped away and the edge layer is etched to the exposed discrete shaving elements, each having a peripheral edge and a sharpness sufficient to cut hair. The substrate around the discrete shaving elements is also exposed so that the cutting edges are offset from at least one surface of the substrate.

### CROSS-REFERENCE TO RELATED APPLICATIONS

This application is entitled to the benefit of and incorporates by reference essential subject matter disclosed in Provisional Patent Application No. 60/446,292 filed on Feb. 10, 2003.

### FIELD OF THE INVENTION

The present invention is generally related to shaving implements, and is more particularly directed to a shaving surface defined by a plurality of discrete shaving elements and a method for making the shaving surface.

### BACKGROUND OF THE INVENTION

Historically, razors used for the removal of hair from skin employed one or more blades having longitudinally sharpened edges. These blades have a tendency to cut the user's skin and to otherwise cause discomfort during a shaving operation. In an effort to minimize the danger related to the exposed cutting edges of these razors, guards have been incorporated into the razor design. The guard is generally interposed between the user's skin and the cutting edge of the razor blade. This allows the cutting edge of the blade to pass over a user's skin and cut hair extending outwardly therefrom while minimizing the potential for nicks and cuts. However, this modification affects the closeness of the shave, and is not entirely effective in preventing injury to the user.

Blade structures incorporating multiple apertures each having a sharpened edge have also been disclosed in the prior art. However, experience has shown that the expense associated with manufacturing blades of this type is, at present, prohibitive.

Based on the foregoing, it is the general object of the present invention to provide a shaving surface that overcomes the problems and drawbacks of the prior art.

### SUMMARY OF THE INVENTION

The present invention is directed in a first aspect to a method for making a microedged shaving surface wherein a substrate has a layer of polymer applied over at least a surface thereof. An edge layer of material is deposited over the polymer layer and has hardness sufficient to support a cutting edge. The edge layer is coated with a photoresist material which is then cured to render selected areal portions thereof, substantially impervious to removal by etching. Once cured, those areal portions of the photoresist material adjacent to the substantially impervious areas are processed so that a plurality of reentrant profiles are created in the polymeric material. The remaining photoresist material is then stripped away, and the edge layer is etched to expose a plurality of discrete shaving elements, each defining a peripheral edge having sharpness sufficient to cut into human hair. The substrate around the discrete shaving elements is then exposed so that the cutting edges are offset from the substrate.

In the preferred embodiment of the present invention, the edge layer is tungsten with a layer of copper located over the tungsten. In addition, the photoresist material comprises a negative resist. However, the present invention is not limited in this regard as a positive resist can also be employed without departing from the broader aspects of the present invention.

The present invention also resides in a second aspect in a microedged-shaving surface wherein a substrate defines a surface having a plurality of micro-protrusions projecting outwardly therefrom. A microedged-shaving element is carried by each of the protrusions. Each shaving element defines a peripheral edge having sharpness sufficient to cut into human hair. Preferably, the protrusions are each frusto-conical in shape and define an upper surface upon which each of the micro-edged shaving elements is supported. It is also preferable that each microedged shaving element be circular and have a sharpened periphery. To ensure the sharpness of the periphery, each shaving element is coated with a metallic layer, which in the preferred embodiment includes tungsten. This layer provides hardness sufficient to allow the cutting edges on each shaving element to be maintained.

An advantage of the present invention lies in the fact that the micro nature of the shaving elements causes then to be less likely to cut the skin of a user. In addition, handling of the shaving surfaces during manufacture is safer.

### BRIEF DESCRIPTION OF THE DRAWINGS

FIG. 1 is a partial, side elevational view of the microedged-shaving surface of the present invention.

FIG. 2 is a partial perspective view of the shaving surface of FIG. 1.

FIG. 3 is a flow chart schematically illustrating a method for producing the shaving surface of FIG. 1.

### DETAILED DESCRIPTION OF THE PREFERRED EMBODIMENT

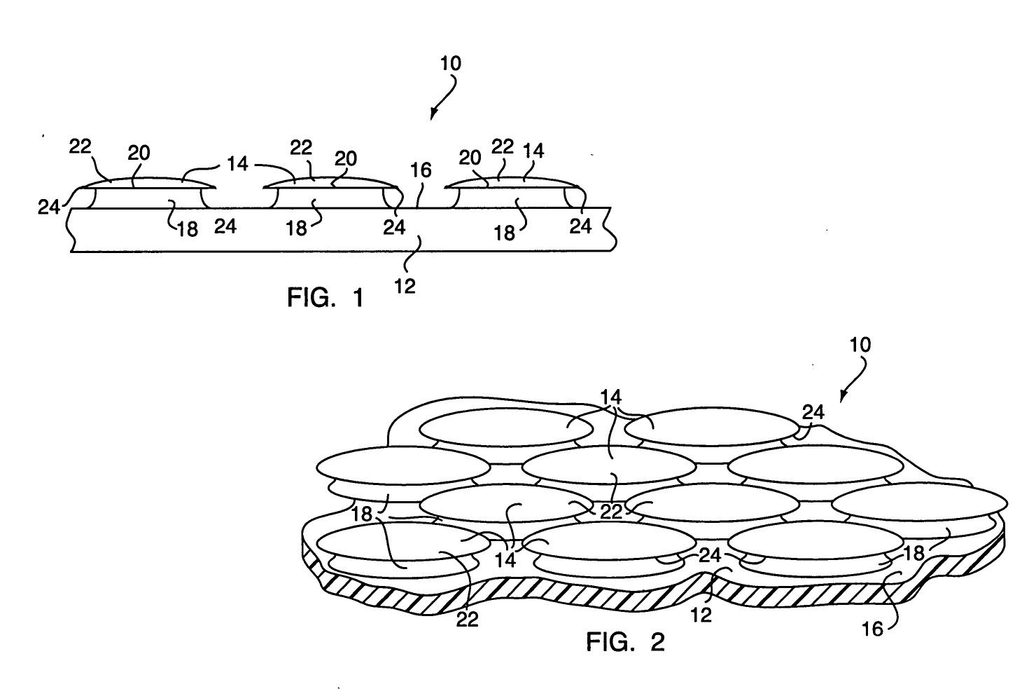

As shown in FIGS. 1 and 2, a microedged shaving surface, generally designated by the reference number 10 includes a substrate 12 made from a suitable material, such as, but not limited to silicon wafer material. A plurality of discrete shaving elements generally designated by the reference number 14 are attached to and project outwardly from a surface 16 defined by the substrate 12. Preferably the shaving elements 14 are formed from a suitable polymeric material, such as, but not limited to polyimide.

In the illustrated embodiment, each discrete shaving element 14 includes a generally frusto-conical support portion 18 attached to and projecting outwardly from the substrate surface 16. Each frusto-conical support portion 18 includes an outer surface 20 adapted to carry a microedged shaving portion 22 thereon. Each shaving portion defines a peripheral cutting edge 24 of sufficient sharpness to cut into human hair when drawn across a user's skin during a shaving operation. While the support portions 18 have been shown and described as being frusto-conical, the present invention is not limited in this regard as other configurations such as cylindrical or polygonal can be substituted. In addition, while the microedged shaving portions 22 have been shown in the illustrated embodiment as being circular, the present invention is not limited in this regard as other shapes, such as, but not limited to oval can also be employed without departing from the broader aspects of the present invention.

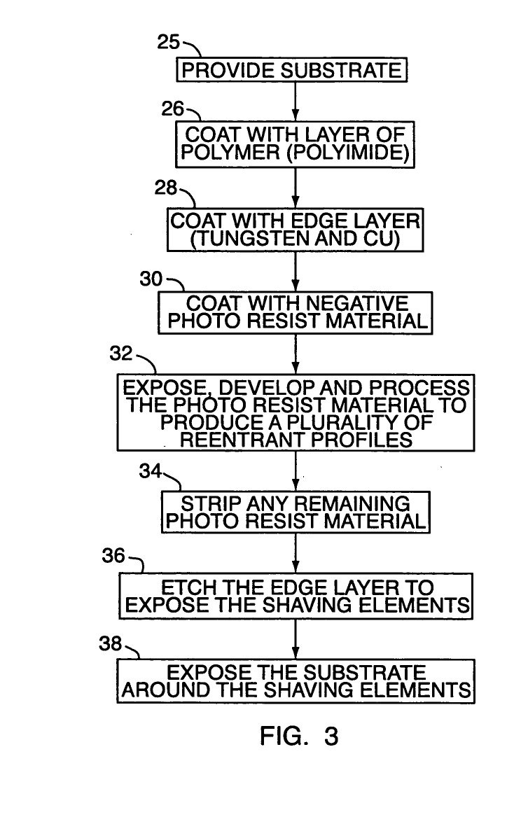

As schematically illustrated in FIG. 3, the shaving surface 10 can be produced by first providing a substrate 24. In the preferred embodiment of the present invention, the substrate can be a silicon wafer of the type used to produce semi-conductors, or the substrate can be a polymeric material, such as, but not limited to polyimide.

Where a silicon wafer is used as the substrate, the next step in producing the above-described shaving surface is to coat the substrate with polymeric material 26, preferably, but not limited to polyimide. A material found to be suitable for coating the substrate is Dupont® polyimide 2525. This material is applied by spinning six coats of the polyimide onto the substrate, each coat being approximately 8 um thick. The material is allowed to cure and then six more coats each approximately 8 um thick are applied and allowed to cure. Next, an edge layer of material 28 of sufficient hardness to support a cutting edge is applied over the polyimide. Preferably, this material is metallic. A material found to be particularly suitable for this application is tungsten sputtered onto the polyimide approximately 800 A thick followed by 1500 A of copper.

Subsequent to the application of the edge layer 28, the substrate is coated with a negative photoresistive material 30 which is exposed and developed to define areal portions thereof substantially impervious to removal by etching. These areal portions correspond to a pattern of discrete, individual, shaving elements. The negative resist is then processed to create a reentrant photo resist profile. The substrate with the above-described layers of different material thereon is then plated with nickel to provide a support layer to strengthen the whole shaving surface structure. Any remaining photoresist material is next stripped away 32 by dry or chemical etching. While a negative resist material has been shown and described, the present invention is not limited in this regard as a positive resist material may also be employed without departing from the broader aspects of the present invention.

The next step in the thus far described process is to etch the edge layer 34 by etching back the copper layer with a nitric acid (HNO3) solution down to the tungsten layer. Then the tungsten layer is etched through 36 by, reactive ion etching (RIE), down to the polyimide layer. The nickel layer is then wet etched leaving the tungsten layer intact to pull the nickel back from the peripheral edges of each shaving element to create a thin tungsten cutting edge. Finally the polyimide layer is etched though, using RIE, down to the substrate creating an undercut in the support portions 3818, FIGS. 1 and 2, so that the peripheral edges are exposed.

The microedged-shaving surface 10 can be mounted in any one of a number of different razor configurations. During operation, as the shaving surface 10 is drawn across the skin of a user, the microedged shaving portions contact hair protruding from the user's skin and successively cut into it until it is cut through.

While preferred embodiments have been shown and described, one skilled in the pertinent art to which the present invention pertains will immediately recognize that various modifications and substitutions may be made. Accordingly, it is to be understood that the present invention has been described by way of example, and not by limitation.

What is claimed is:

1. A method for making a microedged shaving surface comprising the steps of:
providing a substrate;
applying a polymer layer onto at least one surface of said substrate;
depositing an edge layer of material over said polymer layer, said edge layer having hardness sufficient to support a cutting edge;
coating said at least one surface with a photoresist material positioned over said edge layer;
curing said photoresist material to render areal portions thereof substantially impervious to removal by etching;
etching said photoresist materials so that the areas adjacent to said substantially impervious areal portions create a plurality of re-entrant profiles;
stripping any remaining photoresist material;
etching said edge layer to expose said discrete shaving elements, each defining a peripheral edge having a sharpness sufficient to cut into hair; and
exposing said substrate around said discrete shaving elements so that said cutting edges are offset from said at least one surface of said substrate.

2. A method as defined by claim 1, wherein said step of depositing an edge layer of material includes depositing a layer of tungsten.

3. A method as defined by claim 2 wherein said layer of tungsten is approximately 800 angstroms thick.

4. A method as defined by claim 2 wherein said step of depositing an edge layer of material includes depositing a layer of copper over said layer of tungsten.

5. A method as defined by claim 1 wherein after said step of curing said photoresist material, the method includes the step of plating said substrate with nickel.

6. A method as defined by claim 1 wherein said step of curing includes exposing said photoresist material to ultraviolet radiation and processing said photoresist material to create a reentrant angled photoresist profile.

7. A method as defined by claim 4 wherein said step of etching said edge layer includes wet etching said copper layer with a nitric acid solution and reactive ion etching said tungsten layer.

8. A method as defined by claim 7 wherein after said step of curing said photoresist material, the method includes the further step:
of plating said substrate with nickel, and wherein after said step of reactive ion etching said tungsten layer, said method includes the further step of
wet etching said nickel to create a tungsten extension.

9. A method as defined by claim 1 wherein said substrate is formed from a polymeric material.

10. A method as defined by claim 9 wherein said polymeric material is polyimide.

11. A microedged shaving surface comprising:
a substrate defining a surface having a plurality of micro-protrusions projecting outwardly therefrom; and
a plurality of microedged shaving elements, each being carried by one of said micro protrusions, each shaving element defining a peripheral edge having sharpness sufficient to cut into human hair.

12. A microedged-shaving surface as defined by claim 11 wherein:
each of said protrusions is frusto-conically shaped defining an upper surface upon which one of said microedged shaving elements is supported; and wherein
each of said microedged shaving elements is approximately circular with said peripheral edged extending past said upper surface but not engaging the peripheral edge of any other of said plurality of microedged shaving elements.

13. A microedged-shaving surface as defined by claim 11 wherein said plurality of protrusions are positioned in an array.

14. A microedged shaving surface as defined by claim 13 wherein said array comprises a plurality of rows wherein each protrusion is spaced away from the next adjacent protrusion in all directions.

15. A microedged-shaving surface as defined by claim 11 wherein said substrate, said plurality of protrusions, and said microedged shaving elements are polymeric.

16. A microedged-shaving surface as defined by claim 15 wherein said substrate, said plurality of protrusions, and said microedged shaving elements are formed from polyimide.

17. A microedged shaving surface as defined by claim 15 wherein said plurality of said microedged shaving elements are coated with a metallic material.

18. A microedged shaving surface as defined by claim 17 wherein said metallic material is tungsten.

19. A microedged-shaving surface made in accordance with the method of claim 1.
